(19) United States
(12) Patent Application Publication
(10) Pub. No.: US 2020/0184194 A1
(43) Pub. Date: Jun. 11, 2020

(54) OBJECT OF INTEREST DATABASE MANAGEMENT USING INSPECTION DATA

(71) Applicant: Honeywell International Inc., Morris Plains, NJ (US)

(72) Inventors: Thandava Krishna Edara, Plymouth, MN (US); Manik Mahesh Jahagirdar, Edina, MN (US); Shailendra Singh, Bloomington, IL (US)

(21) Appl. No.: 16/365,214

(22) Filed: Mar. 26, 2019

Related U.S. Application Data
(60) Provisional application No. 62/775,758, filed on Dec. 5, 2018.

(51) Int. Cl. G06K 9/00; G06K 9/03; G06F 16/29; G06T 17/05; G06N 3/02; B64C 39/02

(52) U.S. Cl. CPC G06K 9/00208; G06K 9/03; G06F 16/29; B64C 2201/123; G06N 3/02; B64C 39/024; G06T 17/05

(57) ABSTRACT

A device for database management includes processing circuitry configured to convert inspection data into a 3D model, the inspection data being generated using one or more sensors arranged on a vehicle, and identify a plurality of objects of interest using the inspection data, the 3D model, or a combination of the inspection data and the 3D model. The processing circuitry is configured to estimate respective geographical location information for each object of the plurality of objects of interest using the 3D model and generate a database using the geographical location information for each object of the plurality of objects of interest.

### PRIORITY CLAIM

This application claims the benefit of U.S. Provisional Patent Application No. 62/775,758, filed Dec. 5, 2018, the entire content of which is incorporated herein by reference.

### TECHNICAL FIELD

This disclosure relates to systems for managing objects of interest.

### BACKGROUND

Vehicles, such as Unmanned Aerial Vehicles (UAVs) have the potential to dramatically improve the process of inspecting various inspection targets, such as bridges, electrical transmission towers, agricultural fields, buildings, antennas, and so on. For instance, a UAV may be able to more quickly access large geographical areas compared to a person walking or using land vehicles, which may reduce risk to human beings.

### SUMMARY

In general, this disclosure relates to techniques that improve computing systems for managing objects of interest (e.g., assets). For example, techniques of this disclosure may improve safety when using vehicles, such as, but not limited to, an Unmanned Aerial Vehicles (UAVs) to identify objects of interest.

In one example, a device for database management includes a memory and processing circuitry coupled to the memory that is configured to: convert inspection data into a 3D model, the inspection data being generated using one or more sensors arranged on a vehicle; identify a plurality of objects of interest using the inspection data, the 3D model, or a combination of the inspection data and the 3D model; estimate respective geographical location information for each object of the plurality of objects of interest using the 3D model; and generate a database using the geographical location information for each object of the plurality of objects of interest.

In another example, a method for database management includes: generating, using one or more sensors arranged on a vehicle, inspection data; converting, by processing circuitry, the inspection data into a 3D model; identifying, by the processing circuitry, a plurality of objects of interest using the inspection data, the 3D model, or a combination of the inspection data and the 3D model; estimating, by the processing circuitry, respective geographical location information for each object of the plurality of objects of interest using the 3D model; and generating, by the processing circuitry, a database using the geographical location information for each object of the plurality of objects of interest.

In another example, a system for database management includes a vehicle comprising one or more sensors configured to generate inspection data and processing circuitry. The processing circuitry is configured to: convert the inspection data into a 3D model; identify a plurality of objects of interest using the inspection data, the 3D model, or a combination of the inspection data and the 3D model; estimate respective geographical location information for each object of the plurality of objects of interest using the 3D model; and generate a database using the geographical location information for each object of the plurality of objects of interest.

In one example, a computer-readable data storage medium includes instructions that, when executed, cause a computing system to: convert inspection data into a 3D model, the inspection data being generated using one or more sensors arranged on a vehicle; identify a plurality of objects of interest using the inspection data, the 3D model, or a combination of the inspection data and the 3D model; estimate respective geographical location information for each object of the plurality of objects of interest using the 3D model; and generate a database using the geographical location information for each object of the plurality of objects of interest.

In another example, a device for database management includes: means for generating inspection data; converting the inspection data into a 3D model; means for identifying a plurality of objects of interest using the inspection data, the 3D model, or a combination of the inspection data and the 3D model; means for estimating respective geographical location information for each object of the plurality of objects of interest using the 3D model; and means for generating a database using the geographical location information for each object of the plurality of objects of interest.

The details of one or more examples of the disclosure are set forth in the accompanying drawings and the description below. Other features, objects, and advantages will be apparent from the description, drawings, and claims.

### BRIEF DESCRIPTION OF THE DRAWINGS

FIG. 1 shows an example system for managing objects of interest using aerial inspection data, which may be configured to implement the techniques of this disclosure.

FIG. 2 is a flowchart illustrating an example process for management of an object of interest database using aerial inspection data, in accordance with a technique of this disclosure.

FIG. 3 is a block diagram illustrating example components of a UAV that may be used to implement techniques of this disclosure.

FIG. 4 is a block diagram illustrating example components of an inspection management system, in accordance with a technique of this disclosure.

FIG. 5 is a flow diagram illustrating an example process of managing objects of interest using aerial inspection data, in accordance with a technique of this disclosure.

### DETAILED DESCRIPTION

Large industrial companies (e.g., utilities, renewables, etc.) may own thousands of assets spread across a large geographic area (e.g., transmission powerlines). With time, these companies may either update or add new assets to support a growing customer base. These ad-hoc asset updates may be difficult to manually track in an asset and/or geographical information system (GIS) database, which may add error to the database. Having an accurate asset database (along with locations) may reduce the overall maintenance time while improving safety.

Configuring a computing system to perform techniques of this disclosure may provide a way to use inspection data (e.g., images, optical, infrared, LIDAR, radar, etc.) with appropriate data analytics tools to automatically locate, identify any newly installed and/or moved assets, and update a customer's asset database on regular intervals. Configuring a computing system to perform techniques of this disclosure may help to create and maintain an asset database. For example, techniques described herein for using inspection data may improve an accuracy of data stored in a database. While the above example manages assets, in other examples a computing system may manage other objects of interest, for example, but not limited to, cracks in a structure, a landing area for a vehicle, or another object of interest.

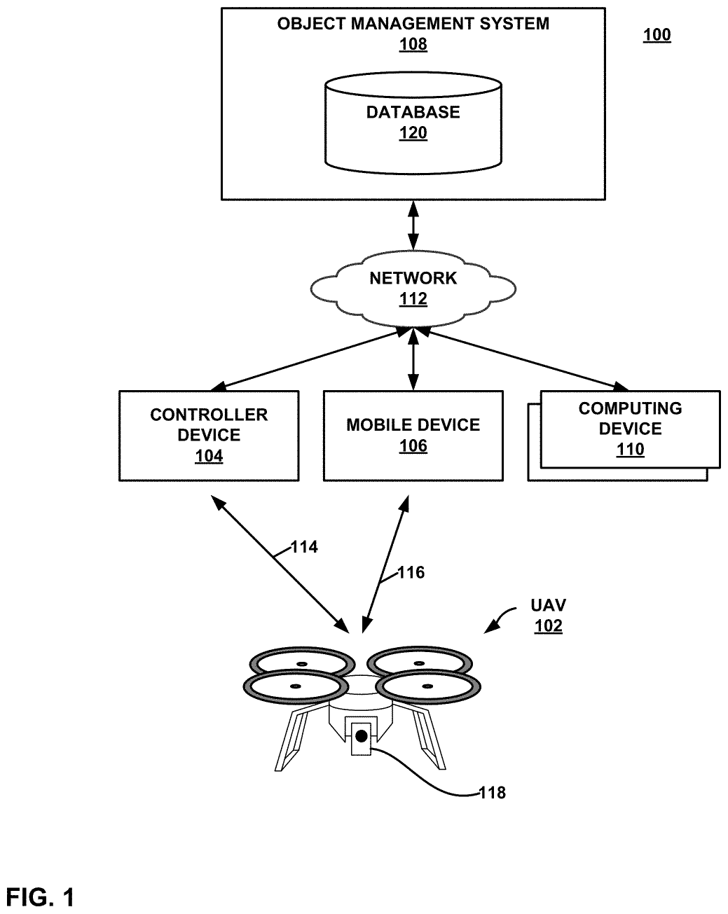

FIG. 1 shows an example system 100 for managing objects of interest using aerial inspection data, which may be configured to implement the techniques of this disclosure. In the example of FIG. 1, system 100 includes a UAV 102, a controller device 104, a mobile device 106, an object of interest management system 108 (referred to herein as “object management system 108”), one or more computing devices 110, and a network 112. In system 100, a UAV pilot may use controller device 104 to control a flight path of UAV 102. An inspector may use mobile device 106 to control sensors, such as sensors, mounted on UAV 102 to perform an aerial inspection of an inspection target. Object management system 108 provides resources to support an end-to-end workflow for UAV-based aerial inspections. Users may use computing devices 110 to interact with object management system 108. Network 112 facilitates communication among controller device 104, mobile device 106, object management system 108, and computing devices 110.

Although shown as separate devices in FIG. 1, in other examples, the functionality of controller device 104 and mobile device 106 may be performed by a common device. In some examples, UAV 102 is sufficiently autonomous to avoid the need to have a pilot use a controller device, such as controller device 104, to navigate UAV 102 along a flight path. In instances where UAV 102 is 100% autonomous (or at least partially autonomous), UAV 102 may perform data collection with high repeatability and may be used for time series analysis of assets database that may build over a period of several weeks/months/years, etc. In some examples, however, UAV 102 may not be autonomous and/or may be controlled at least partially by a human operator. For instance, UAV 102 may be operated 100% manually (e.g., by a human being) or combination of manual control and autonomous flight.

UAV 102 is shown in FIG. 1 as a quadcopter, but UAV 102 may be any type of UAV including, but not limited to, a rotorcraft, a fixed wing aircraft, compound aircraft such as tilt-rotor, X2 and X3, an aerostat, or any other such type of UAV including all vertical take-off and landing (VTOL), tail-sitter, etc. UAV 102 may be configured to fly with various degrees of autonomy. In some examples, UAV 102 may be under the constant, or near constant, control of a user of controller device 104. In other examples, controller device 104 may deliver a mission, including a flight plan, to UAV 102, and onboard processing circuitry of UAV 102 may be configured to execute the mission, with little or no additional user input. In some examples, UAV 102 may use LIDAR for collision avoidance.

Although the techniques of this disclosure are not limited to any particular type of UAV, UAV 102 may, for example, be a relatively small, low altitude, and low-speed UAV, where in this context, small corresponds to under 100 pounds (lbs), low altitude corresponds to operating altitudes less than 3000 feet above ground, and low air speed corresponds to air speeds less than 250 knots. Furthermore, it is contemplated that UAV 102 may have hovering capabilities, meaning UAV 102 may have the capability of remaining at an approximately constant location in the air.

In some examples, controller device 104, mobile device 106, and computing devices 110 each comprises a general-purpose device such as a laptop or desktop computer, a tablet computer, a cellular or satellite radio telephone, a smart phone, or another such device. In examples where controller device 104 is a general-purpose device, controller device 104 may be loaded with and configured to execute software designed to control UAV 102. In other examples, controller device 104 is a special-purpose device designed specifically for use in controlling UAV 102. In some examples, controller device 104 comprises a display screen that may display information, such as flight plan information, to a user. In some examples, controller device 104 communicates with object management system 108 to obtain and send data, such as flight plan data.

Controller device 104 communicates with UAV 102 via communication link 114. Communication link 114 may, for example, be a direct link through a radio communication protocol, such as WiFi, Bluetooth, ZigBee, a proprietary protocol, or any other suitable protocol. In other examples, communication link 114 is a network-based link where controller device 104 communicates with UAV 102 through one or more intermediary devices such as gateways, routers, switches, repeaters, or other such network devices.

In some examples, UAV 102 is configured to stream data to mobile device 106 in real-time or near real time via, for example, a wireless communication link 116. Mobile device 106 may also provide commands to UAV 102 via communication link 116. Communication link 116 may be implemented in a manner similar to communication link 114.

Object management system 108 comprises one or more computing devices. For example, object management system 108 may comprise one or more computing devices, such as a laptop or desktop computer, a tablet computer, a server device, or another such device. Object management system 108 may be loaded with and configured to execute software designed to provide resources to support an end-to-end workflow for UAV-based aerial inspections. One or more sensors 118 are mounted on UAV 102. Sensors 118 may include one or more sensors capable of capturing images of visible light, infrared light, LIDAR, radar, or another type of sensor data.

UAV 102 may perform aerial inspections of various types of inspection targets. For example, an inspection target may be a building, a dam, a solar panel array, a wind turbine, a monument, a bridge, a levee, a seawall, a pier, an antenna, a volcano, a pump station, an agricultural area, an electrical transmission tower, a gas pipeline, or another type of artificial or natural structure. In some examples, UAV 102 may perform a horizontal inspection, for example, by capturing aerial inspection data (e.g., images, optical, infrared, LIDAR, radar, etc.) while flying parallel to a surface of the earth. In some examples, UAV 102 may perform a vertical inspection, for example, by capturing aerial inspection data (e.g., images, optical, infrared, LIDAR, radar, etc.) while flying perpendicular to a surface of the earth. An example of a vertical inspection may include, but is not limited to, for example, an inspection of a chimney at a nuclear power plant.

In some examples, UAV 102 saves the captured aerial inspection data on a Secure Digital (SD) card or other type of memory card, and additionally or alternatively may also transfer on-line to a cloud-based web server using 3G, 4G, 5G, Narrow Band-Internet of Things (NBIOT), or another wireless type of transmission technologies. In some examples, UAV 102 is equipped with one or more differential Global Navigation Satellite System (GNSS) devices to assist UAV 102 navigate to the aerial inspection data capture locations. For instance, UAV 102 may be equipped for real-time kinematics, which is a type of differential GNSS that may provide high positioning performance for UAV 102 in the vicinity of a base station. In some examples, accuracy of the GNSS devices may be within 1 centimeter.

In the example of FIG. 1, object management system 108 comprises a database 120. Database 120 may store information related to inspection projects. Database 120 may be implemented in various ways. For example, database 120 may comprise one or more relational databases, object-oriented databases, comma-separated value (CSV) files, or other types of databases. Database 120 may store aerial inspection data captured by UAV 102, a 3D model representing the aerial inspection data captured by UAV 102, and/or a database indicating objects of interest and respective geographical location information (e.g., latitude and longitude coordinates) for each of the objects of interest. In some examples, database 120 may store one or more physical properties of an object of interest. Examples of physical properties may include, for example, but are not limited to, a height, a width, a depth, an asset class, an area, a volume, or another physical property of an object of interest.

Object management system 108 may be configured to provide an automated end-to-end solution to locate and identify customer's assets and update the asset/geographical information system (GIS) database with help of aerial data collected as part of (periodic) aerial inspections. Specifically, for example, object management system 108 may be configured to perform the following example workflow. Using aerial inspection data, object management system 108 may be configured to automatically recognize and locate assets of interest. In this example, object management system 108 may be configured to automatically match the recognized assets with a priori asset data. In this example, object management system 108 may be configured to automatically reconcile any difference and update the asset database with newly recognized information. If no a priori information is available, object management system 108 may be configured to create a new asset database.

If a priori asset database is available, object management system 108 may be configured to use the information to create optimal aerial data collection plan. If a priori information is not available, object management system 108 may be configured to create the data collection plan using publicly available information. Object management system 108 may be configured to implement a software feature to detect the objects of interest (e.g., assets) in the collected aerial data. Object management system 108 may be configured to implement a software feature to estimate the global and local locations of all the detected objects of interests. Object management system 108 may be configured to implement a software feature to cross-reference the estimated locations of know objects to account for any error in locations estimations and update the estimated location of all unknown objects.

As used herein, a known object may refer to an object of interest whose location information is available in a customer's GIS data. As used herein, an unknow object may refer to an object of interest whose information is not available in GIS data (e.g. newly installed assets). Object management system 108 may be configured to work with all types of aerial mapping payloads, such as, but not limited to, for example, optical, IR, LiDAR, radar or any combination of these payloads. Object management system 108 may be implemented in a cloud. In some examples, object management system 108 may be implemented within UAV 102. In some examples, object management system 108 may implemented in a computing system discrete from UAV 102.

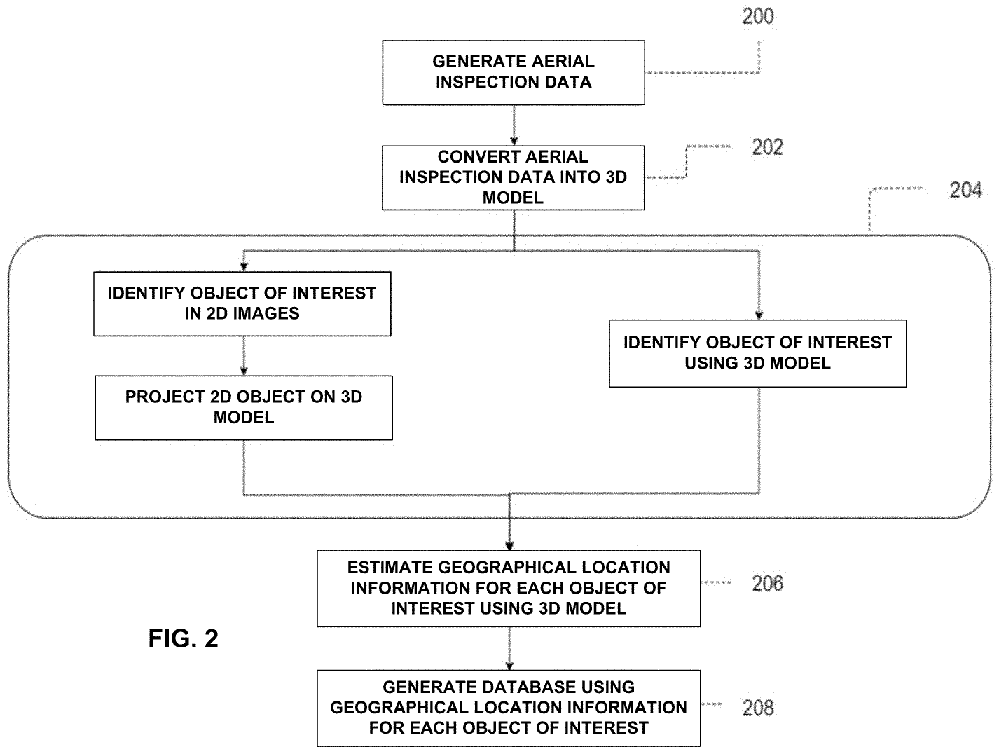

FIG. 2 is a flowchart illustrating an example process for management of an object of interest database using aerial inspection data, in accordance with a technique of this disclosure. In the example of FIG. 2, UAV 102 generates aerial inspection data (200). Object management system 108 converts the aerial inspection data into a 3D model (202). Object management system 108 may be configured to use any suitable software to convert images into a 3D model, such as, for example, a georeferenced 3D model. In some examples, object management system 108 may perform a Structure From Motion (SFM) technique to convert images to a 3D model. As used herein a georeferenced 3D model may refer to a 3D model that is configured to specify each object of interest with a respective position in a georeferenced coordinate system such as, but not limited to, a latitude-longitude (Lat-Lon) coordinate system.

Object management system 108 may be configured to use a software to convert images into a 3D model that is not a georeferenced 3D model. In this example, object management system 108 may be configured to extract a 3D location of an object of interest relative to a takeoff point of UAV 102. For instance, object management system 108 may be configured to determine geographical location information for an object using a relative location extracted from a 3D model for an object of interest specifying that the object of interest is 10 meters (m) right from a takeoff point and a Lat-Lon location of the takeoff point of UAV 102.

Object management system 108 identifies objects of interest using the 3D model (204). As shown in FIG. 2, object management system 108 may be configured to identify an object of interest using 2D images and/or using a 3D model. In some examples, object management system 108 may be configured to identify objects of interest using only a 3D model. In other examples, object management system 108 may be configured to identify of objects of interest using only a 2D model (e.g., aerial inspection data). For example, object management system 108 may be configured to identify one or more assets using only a 2D model. In some examples, object management system 108 may be configured to identify a landing area for landing UAV 102 using only a 2D model.

For object identification, object management system 108 may be configured to use a 3D model to detect objects of interest directly. For example, object management system 108 may be configured to identify one or more assets using a 3D model. In some examples, object management system 108 may be configured to identify a landing area for landing UAV 102 using a 3D model.

Object management system 108 may be configured to apply advance techniques, such as, but not limited to, neural networks or with classical methods like kd-tree or oct-tree, which may provide information about how 3D points in a 3D model are connected to each other and may define criterion to estimate whether a 3D model matches with a shape of an object of interest. For example, object management system 108 may be configured to estimate a portion of the 3D model matches with a shape of an object of interest of a plurality of objects of interest. In this example, object management system 108 may be configured to extract a location of the portion of the 3D model to estimate geographical location information for the object of interest. In some examples, object management system 108 may be configured to apply a neural network to identify a 3D object. For instance, object management system 108 may be configured to apply a neural network to identify 3D points in a 3D model for a 3D object of interest.

For object identification, object management system 108 may be configured to detect an object in 2D images and then project the 2D detected object onto a 3D model to extract the object's 3D location. For example, object management system 108 may be configured to project a 2D object onto the 3D model to determine a 3D object of interest and extract a location of the 3D object using the 3D model. In this example, 2D images may refer to the images that were used to build the 3D model. In some examples, 2D images may be included in aerial inspection data. In this example, a 2D object may refer to a part of an input image (so the 2D object may be represented by a subset of pixels from that image). For example, object management system 108 may be configured to identify a part of the 2D image of aerial inspection data for the 2D object.

Object management system 108 may be configured to detect a 2D object with any neural network-based approach, any classical image processing approach like keypoint matching, or another detection technique. For example, object management system 108 may be configured to apply a neural network to identify a 2D object. For instance, object management system 108 may be configured to apply a neural network to identify a part of an input image corresponding to a 2D object.

Object management system 108 estimates geographical location information for each object of interest using the 3D model (206). Object management system 108 generates a database using the geographical location information for each object of interest (208). For example, object management system 108 may be configured to generate database 120 to include a table having a first column for a serial number for a respective object of interest, a second column for a latitude position for a respective object of interest, a third column for a longitudinal position for a respective object of interest.

In some examples, object management system 108 may be configured to generate database 120 to include the table to further include a fourth column indicating whether a respective object of interest was previously known based on a comparison of the latitude and longitude positions for the respective object of interest with latitude and longitude positions of a known object of interest in an existing database. Said differently, for example, object management system 108 may be configured to compare the respective geographical location information for an object to a respective location of each known object of one or more known objects of interest. In some examples, in response to determining the respective geographical location information for the object corresponds to the respective location of a known object of the one or more known objects of interest, object management system 108 may be configured to indicate the object of interest is known in an entry of database 120. Similarly, in some examples, in response to determining the respective geographical location information for the object does not correspond at least one of the respective locations of the one or more known object of interest, object management system 108 may be configured to add an entry in database 120 indicating the object of interest. In some examples, object management system 108 may be configured to indicate that the object of interest was previously not known in the database.

Object management system 108 may be configured to generate database 120 to further include a column indicating a physical property for an object of interest. For example, object management system 108 may indicate a size (e.g., volume, area, etc.) of an object of interest and/or an asset class for the object of interest. For example, object management system 108 may identify one or more physical properties for an object of interest using the inspection data, the 3D model, or a combination of the inspection data and the 3D model. In this example, to generate the database, object management system 108 may be configured to indicate the one or more physical properties for the object of interest in an entry of database 120. Object management system 108 may be configured to determine positional error information based on the comparison of the latitude and longitude positions for the respective object of interest with latitude and longitude positions of the known object of interest in an existing database. In this example, object management system 108 may be configured to account for the positional error. For example, in response to determining the respective geographical location information for an object corresponds to the respective location of the known object, object management system 108 may be configured to determine positional error information based on a comparison of the respective geographical location information for the object to a respective location of a known object and modify the location of the known object of interest using the position error. For instance, object management system 108 may be configured to subtract the positional error from geographical location information for each (e.g., known and unknown) object of interest in database 120. While examples herein may use latitude and longitude positions, other examples, may use other coordinate systems, such as, but not limited to, Universal Transverse Mercator (UTM), Geocentroid, etc.) to represent a location of an object of interest. Object management system 108 may be configured to represent an object location in a local coordinate system (e.g., 10 m toward right from a first asset).

Object management system 108 may be configured to generate database 120 to indicate one or more object of interests that include landing areas for UAV 102. For example, object management system 108 may determine that an area of an object of interest satisfies an area threshold for UAV 102. For example, object management system 108 may identify one or more landing areas using the inspection data, the 3D model, or a combination of the inspection data and the 3D model that satisfy (e.g., exceed) an area threshold for landing UAV 102. In this example, to generate the database, object management system 108 may be configured to indicate that an object of interest is a landing area in an entry of database 120. As such, UAV 102 may use database 120 to determine a closest location to safely land to improve a safety of UAV 102.

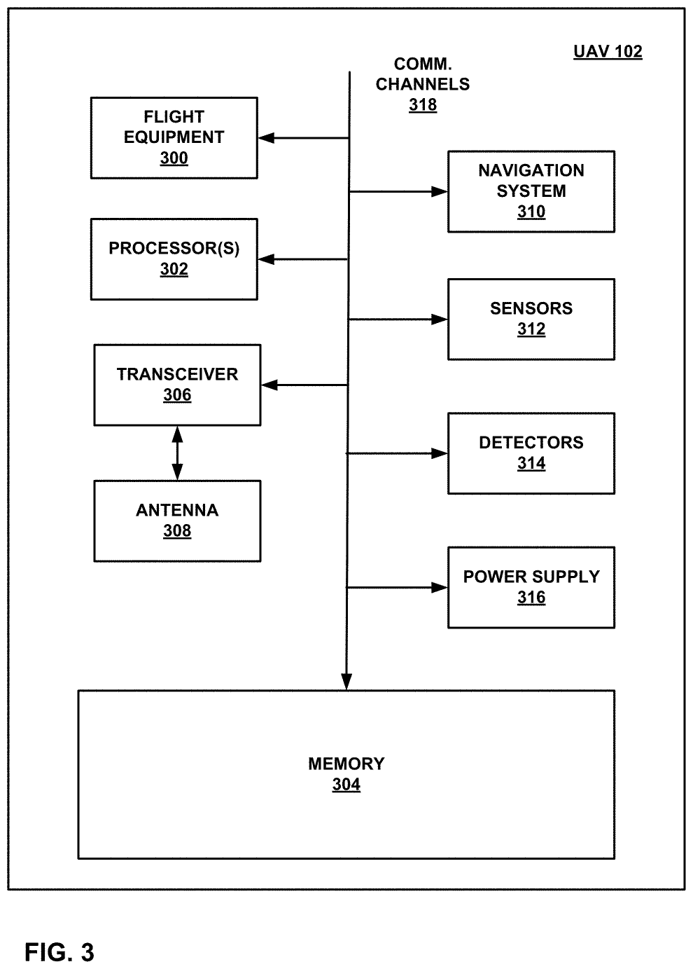

FIG. 3 shows an example illustration of UAV 102. UAV 102 includes flight equipment 300, processor 302, memory 304, transceiver 306, antenna 308, navigation system 310, sensors 312, detectors 314, and power supply 316. Communication channels 318 interconnect each of flight equipment 300, processor 302, memory 304, transceiver 306, antenna 308, navigation system 310, sensors 312, detectors 314, and power supply 316 for inter-component communications (physically, communicatively, and/or operatively). In some examples, communication channels 318 include a system bus, a network connection, an inter-process communication data structure, or any other method for communicating data, including various types of wireless communication technologies. Power supply 316 may provide electrical energy to each of the other components of UAV 102. In some examples, power supply 316 is a battery.

Processor 302 is intended to represent all processing circuitry and all processing capabilities of UAV 102. Processor 302 may, for example, include one or more digital signal processors (DSPs), general purpose microprocessors, integrated circuits (ICs) or a set of ICs (e.g., a chip set), application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Memory 304 is intended to represent all of the various memory devices within UAV 102. Memory 304 constitutes a computer-readable storage medium and may take the form of either a volatile memory that does not maintain stored contents once UAV 102 is turned off or a non-volatile memory that stores contents for longer periods of time, including periods of time when UAV 102 is an unpowered state. Examples of volatile memories include random access memories (RAM), dynamic random-access memories (DRAM), static random access memories (SRAM), integrated random access memory (IRAM), thyristor random access memory (TRAM), zero-capacitor random access memory (ZRAM), or any other type of suitable volatile memory. Examples of non-volatile memory include optical disk drives, magnetic disk drives, flash memory, read only memory (ROM), forms of electrically programmable memories (EPROM) or electrically erasable and programmable memories (EEPROM), or any other such type of non-volatile memory.

The functionality of UAV 102 is implemented by hardware, software, firmware, or combinations thereof. Memory 304 may store software and firmware that include sets of instructions. Processor 302 and, other hardware components of UAV 102, may execute the instructions to perform the techniques of this disclosure.

Transceiver 306 is configured to send and receive data using antenna 308. Transceiver 306 may send and receive data according to any of the wireless communication protocols described elsewhere in this disclosure. For example, transceiver 306 may be configured to receive navigation instructions. Additionally, transceiver 306 may be configured to send images and other data to a computing system, such as controller device 104 (FIG. 1), mobile device 106, or computing devices 110 (FIG. 1).

Navigation system 310 controls a flight path of UAV 102. For example, navigation system 310 may output signals to flight equipment 300 to instruct UAV 102 to fly to predetermined image capture locations, to land, or to otherwise navigate to locations along a flight path of UAV 102.

Sensors 312 may be configured to generate aerial inspection data. As used herein, aerial inspection data, may include, but is not limited to, for example, optical images, infrared, LIDAR, radar, or other aerial inspection data. In some examples, sensors 312 are configured to capture visible light images. In some examples, the same sensor captures both infrared images and visible light images. In other examples, UAV 102 has separate sensors to capture infrared images and visible light images. Processors 302 may be configured to control sensors 312.

Detectors 314 are intended to represent all the various detectors included in UAV 102. UAV 102 may, for example, include one or more detectors used for flight management, such as accelerometers, gyroscopes, magnetometers, barometers, GNSS detectors, tilt sensors, inertial measurement sensors, speed detectors, and other detectors.

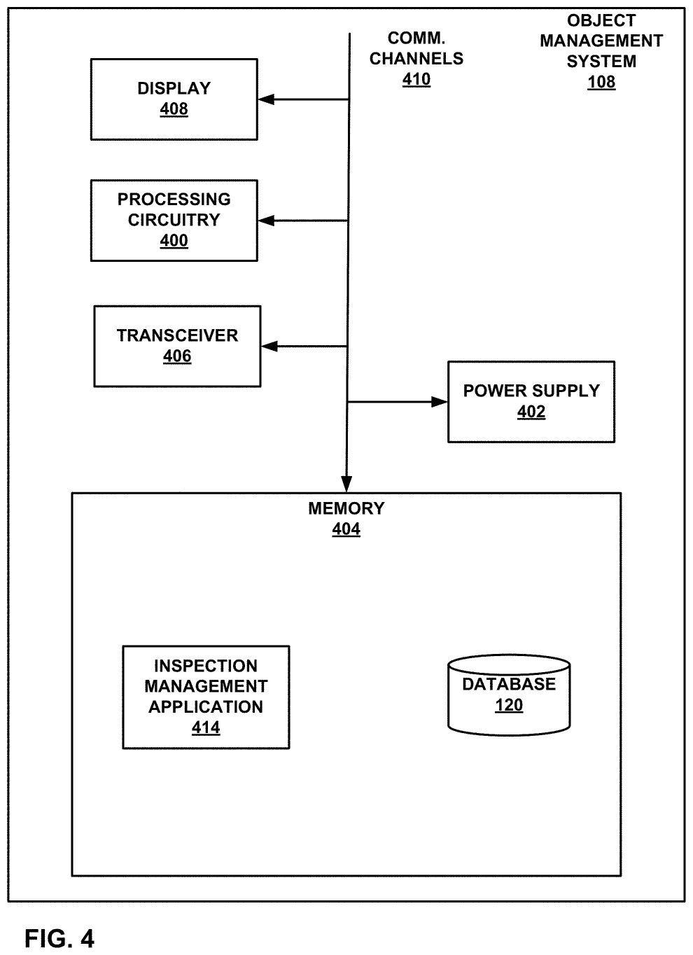

FIG. 4 is a block diagram illustrating example components of object management system 108, in accordance with one or more techniques of this disclosure. In the example of FIG. 4, object management system 108 includes one or more processing circuitry 400, a power supply 402, a memory 404, a transceiver 406, a display 408. Communication channels 410 interconnect processing circuitry 400 (also referred to herein as “processing circuitry”), memory 404, transceiver 406, and display 408. Power supply 402 provides power to processing circuitry 400, memory 404, transceiver 406 and display 408. Processing circuitry 400 and memory 404 and may be implemented in a manner similar to processor 302 and memory 304 described above with respect to FIG. 3. Transceiver 406 may comprise a network card, such as an Ethernet adaptor, wireless interface, or other device for sending and receiving data with other computing devices. Display 408 may comprise various types of displays for outputting data, such as liquid crystal displays, plasma displays, light emitting diode (LED) displays, and so on. In other examples, object management system 108 may include more, fewer, or different components. For instance, in some examples, object management system 108 does not include display 408.

In the example of FIG. 4, memory 404 stores database 120 and an inspection management application 414. Database 120 stores data associated with inspection projects, as described elsewhere in this disclosure. For instance, database 120 may comprise tables and data associated with objects of interest, geographical location information, and so on. For instance, database 120 may include a table having a first column for a serial number for a respective object of interest, a second column for a latitude position for a respective object of interest, a third column for a longitudinal position for a respective object of interest, and a fourth column indicating whether a respective object of interest was previously known. Inspection management application 414 may comprise software instructions that, when executed by processing circuitry 400, cause object management system 108 to perform the automatic management of an object of interest database using aerial inspection data described in this disclosure.

While the example of FIG. 4 shows database 120 being within object management system 108, database 120 may be arranged in, for example, but not limited to, controller device 104, mobile device 106, computing device 110, or another device (e.g., as the app running on a phone, tablet, PC, etc.) of system 100. In some examples, database 120 is a temporary database that is later synched with a larger database.

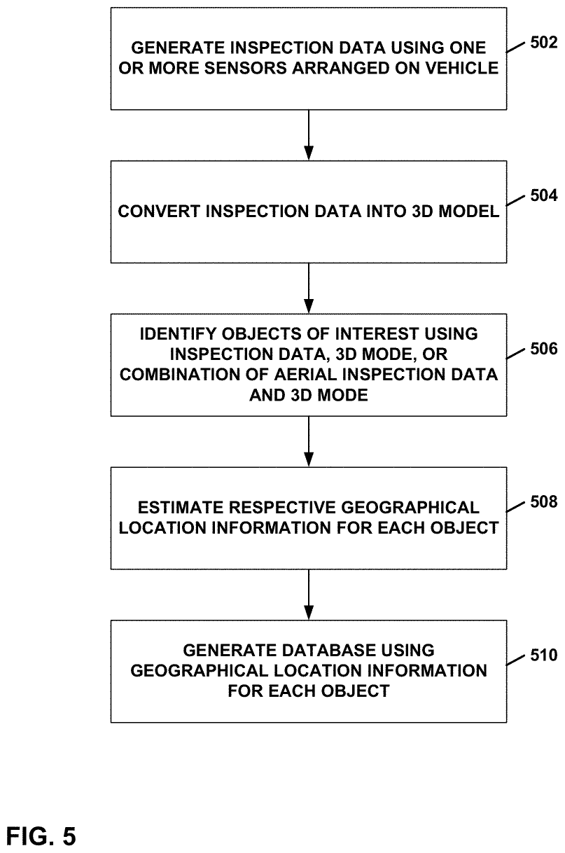

FIG. 5 is a flow diagram illustrating an example process of managing objects of interest using inspection data, in accordance with a technique of this disclosure. FIG. 5 is discussed with reference to FIGS. 1-4 for example purposes only. UAV 102 generates inspection data using one or more sensors 312 arranged on a vehicle (502). Processing circuitry 400 converts the inspection data into a 3D model (504). Processing circuitry 400 identifies a plurality of objects of interest using the inspection data, the 3D model, or a combination of the inspection data and the 3D model (506). Processing circuitry 400 estimates respective geographical location information for each object of the plurality of objects of interest using the 3D model (508). Processing circuitry 400 generates a database using the geographical location information for each object of the plurality of objects of interest (510).

In the example of FIG. 5, processing circuitry 400 is used to convert, identify, estimate, and generate. In some examples, however, processor 302 of UAV 102 may be configured to one or more steps performed by processing circuitry 400. For example, processor 302 may be configured to convert the inspection data into a 3D model. In some examples, processor 302 may be configured to identify a plurality of objects of interest using the inspection data, the 3D model, or a combination of the inspection data and the 3D model. Processor 302 may be configured to estimate respective geographical location information for each object of the plurality of objects of interest using the 3D model. Processor 302 may be configured to generate a database using the geographical location information for each object of the plurality of objects of interest.

While the techniques of this disclosure are described with respect to a UAV for purposes of explanation, it should be understood that the techniques of this disclosure may be implemented by other types of vehicles, including, but not limited to, various types of land-based vehicles, water-based vehicles, space vehicles, and other types of aerial vehicles. Similarly, while the techniques of this disclosure are described with respect to aerial inspection data for purposes of explanation, it should be understood that the techniques of this disclosure may be implemented for other types of inspection data.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units.

Cloud technology used to automatically save the images on web server is not limited to local or global internet cloud. It can be a private and/or public cloud which is protected by the user ID and passwords. The passwords may not limit to one or two.

Various examples have been described. These and other examples are within the scope of the following claims.

What is claimed is:

1. A device for database management, the device comprising:
a memory; and
processing circuitry coupled to the memory and configured to:
convert inspection data into a 3D model, the inspection data being generated using one or more sensors arranged on a vehicle;
identify a plurality of objects of interest using the inspection data, the 3D model, or a combination of the inspection data and the 3D model;
estimate respective geographical location information for each object of the plurality of objects of interest using the 3D model; and
generate a database using the geographical location information for each object of the plurality of objects of interest.

2. The device of claim 1, wherein, to generate the database, the processing circuitry is configured to:
compare the respective geographical location information for an object of the plurality of objects of interest to a respective location of each known object of one or more known objects of interest.

3. The device of claim 2, wherein, to generate the database, the processing circuitry is configured to:
in response to determining the respective geographical location information for the object corresponds to the respective location of a known object of the one or more known objects of interest, indicate the object of interest is known in an entry of the database.

4. The device of claim 3, wherein the processing circuitry is configured to, in response to determining that the respective geographical location information for the object corresponds to the respective location of the known object:
determine positional error information based on the comparison; and
modify the location of the known object of interest using the position error.

5. The device of claim 2, wherein, to generate the database, the processing circuitry is configured to:
in response to determining the respective geographical location information for the object does not correspond at least one of the respective locations of the one or more known object of interest, add an entry in the database indicating the object of interest.

6. The device of claim 5, wherein, to add the entry in the database, the processing circuitry is configured to add the entry in the database to indicate that the object of interest was previously not known in the database.

7. The device of claim 1, wherein, to identify the plurality of objects of interest, the processing circuitry is configured to identify a 2D object of interest using the inspection data and wherein, to estimate the respective geographical location information, the processing circuitry is configured to:
project the 2D object onto the 3D model to determine a 3D object of interest; and
extract a location of the 3D object using the 3D model.

8. The device of claim 7,
wherein the inspection data comprises a 2D image; and
wherein, to identify the 2D object, the processing circuitry is configured to identify a part of the 2D image for the 2D object.

9. The device of claim 7, wherein, to identify the 2D object, the processing circuitry is configured to apply a neural network.

10. The device of claim 1, wherein, to identify the plurality of objects of interest, the processing circuitry is configured to estimate a portion of the 3D model that matches with a shape of an object of interest of the plurality of objects of interest.

11. The device of claim 10, wherein, to estimate the respective geographical location information, the processing circuitry is configured to extract a location of the portion of the 3D model.

12. The device of claim 10, wherein, to estimate the portion of the 3D model that matches with the shape of the object of interest, the processing circuitry is configured to apply a neural network.

13. The device of claim 1, wherein the object of interest comprises an asset.

14. The device of claim 1, wherein the inspection data is aerial inspection data and wherein the vehicle is an Unmanned Aerial Vehicle (UAV).

15. The device of claim 1,
wherein the processing circuitry is arranged within the vehicle;
wherein the processing circuitry is arranged outside of the vehicle; or
wherein the processing circuitry comprises a first processor arranged within the vehicle and a second processor arranged outside of the vehicle.

16. The device of claim 1, wherein the processing circuitry is configured to:
identify one or more physical properties for an object of the plurality of objects of interest using the inspection data, the 3D model, or the combination of the inspection data and the 3D model,
wherein, to generate the database, the processing circuitry is configured to indicate the one or more physical properties for the object of interest in an entry of the database.

17. The device of claim 1, wherein the plurality of objects of interest comprises a landing area for landing the vehicle.

18. A method for database management, the method comprising:
generating, using one or more sensors arranged on a vehicle, inspection data;
converting, by processing circuitry, the inspection data into a 3D model;
identifying, by the processing circuitry, a plurality of objects of interest using the inspection data, the 3D model, or a combination of the inspection data and the 3D model;
estimating, by the processing circuitry, respective geographical location information for each object of the plurality of objects of interest using the 3D model; and
generating, by the processing circuitry, a database using the geographical location information for each object of the plurality of objects of interest.

19. A system for database management comprising:
a vehicle comprising one or more sensors configured to generate inspection data; and
processing circuitry configured to:
convert the inspection data into a 3D model;
identify a plurality of objects of interest using the inspection data, the 3D model, or a combination of the inspection data and the 3D model;
estimate respective geographical location information for each object of the plurality of objects of interest using the 3D model; and
generate a database using the geographical location information for each object of the plurality of objects of interest.

20. The system of claim 19,
wherein the processing circuitry is arranged within the vehicle;
wherein the processing circuitry is arranged outside of the vehicle; or
wherein the processing circuitry comprises a first processor arranged within the vehicle and a second processor arranged outside of the vehicle.
